(19) United States
(12) Patent Application Publication
(10) Pub. No.: US 2020/0188934 A1
(43) Pub. Date: Jun. 18, 2020

(54) METHOD OF SEPARATING SUSPENDED SOLIDS VIA ELECTROSTATIC SEPARATION USING POROUS MATERIALS

(71) Applicant: CRYSTAPHASE PRODUCTS, INC., HOUSTON, TX (US)

(72) Inventors: JOHN N. GLOVER, HOUSTON, TX (US); AUSTIN SCHNEIDER, HUMBLE, TX (US); PETER GREGORY HAM, HOUSTON, TX (US)

(73) Assignee: CRYSTAPHASE PRODUCTS, INC., HOUSTON, TX (US)

(21) Appl. No.: 16/717,598

(22) Filed: Dec. 17, 2019

Related U.S. Application Data
(60) Provisional application No. 62/780,678, filed on Dec. 17, 2018.

(51) Int. Cl. B03C 5/02

(52) U.S. Cl. CPC B03C 5/02; B03C 2201/20; B03C 2201/18

(57) ABSTRACT

A method for removing suspended particles from fluids in an electrostatic separator is provided. Porous materials can be utilized within the electrostatic separator to promote separation of the suspended particles from the fluids. Small particles of catalyst material which may be entrained in a fluid stream (such as an oil) may be filtered, or captured, from the fluid stream and retained by the porous materials including reticulates.

### RELATED APPLICATIONS

This application claims the benefit, and priority benefit, of U.S. Provisional Patent Application Ser. No. 62/780,678, filed Dec. 17, 2018, the disclosure and contents of which are incorporated by reference herein in their entirety.

### BACKGROUND

### 1. Field of the Invention

The presently disclosed subject matter relates generally to removal of particulate materials within industrial process facilities, and more specifically, to removal of suspended particles using electrostatic separators.

### 2. Description of the Related Art

Contaminant particles such as catalyst pieces and other under undesired materials can be found in fluids contained in industrial processes. It is known in the art to use electrostatic separation to remove these contaminants via filtration. The fluid to be cleaned is typically passed through a bed of glass beads maintained in an electrostatic field within an electrostatic bead bed separator. The contaminants are captured as the oil passes through the void spaces surrounding the electrostatically-charged bead surfaces.

Electrostatic bead bed separators are commercially available from companies such as General Atomics of San Diego, Calif. under the brand “Gulftronic™,” and are generally described in U.S. Pat. No. 5,308,586, issued May 3, 1994, the contents and disclosure of which are incorporated by reference herein in their entirety.

These previously known separation processes have a number of disadvantages. For example, bed glass beads have a void volume of about 40% which limits bed filtration volume and bed surface area. Also, glass bead beds attract contaminant particles in monolayers which can be periodically back-flushed. In addition, electrostatic deposition is directly related to and limited by surface area, and efforts to increase process capacity are hindered by pressure drop related to size of beads and surface area.

Improvements in this field are therefore desired.

### DETAILED DESCRIPTION

In accordance with the presently disclosed subject matter, various illustrative embodiments of an improved method for removing suspended contaminant particles from fluids in an electrostatic separator are described herein.

In certain illustrative embodiments, porous materials can be utilized within the electrostatic separator to promote separation of the suspended particles from the fluids. For example, small particles of catalyst material which may be entrained in a fluid stream (such as an oil) may be filtered, or captured, from the fluid stream and retained by electrostatically-charged porous materials. Porous material can be disposed as beds of elements within the electrostatic separator, and can replace, or be used together with, the glass beads within the separator. The porous elements can be composed of metal, ceramic or plastic. The porous elements can be formed as beads, disks and similar structures. A particular form of porous element is 3-dimension reticulates that contain net-like structures of tortuous pathways that traverse the body of the elements. In certain illustrative embodiments, the reticulates have a plurality of web members that define a plurality of flow passageways through the reticulates. A fluid stream contacted with the reticulates is therefore subdivided into a plurality of smaller fluid streams by passing the fluid stream through the plurality of flow passageways defined by the web members of the reticulates. The flows of the fluid stream through the flow passageways within the reticulates and through the void spaces between the reticulates provides for effective flow distribution. Porous materials suitable for using in electrostatic applications include those with ppi's of 5 to 500, sometimes 5 to 200, and sometimes 5 to 100. The oil can be, for example, a hydrocarbon, a vegetable oil, animal grease, soybean oil or the like.

In certain illustrative embodiments, the reticulates can be reticulated materials such as those commercially available from Crystaphase International Inc. under the brand “CatTrap®,” which are generally described in U.S. Pat. No. 6,258,900, issued Jul. 10, 2001, U.S. Pat. No. 7,265,189, issued Sep. 4, 2007, and U.S. Pat. No. 7,722,832, issued May 25, 2010, the contents and disclosure of each of which are incorporated by reference herein in their entirety.

Use of porous materials to promote separation of suspended contaminants (such as catalyst particles) from fluids within an electrostatic separator as described herein has a number of advantages. For example, in certain illustrative embodiments, porous materials provide void volumes of between 60% and 95%, depending on manufacturing method, and inclusive of internal and external voids. Reticulates in particular can provide void volumes in excess of 70% with surface areas exceeding 1000 square meters per cubic meter of material. This surface area allows for enlarged monolayer deposition and resulting increased filtration capacity, reduced pressure drop increases and resistance to process upsets.

Some of these advantages are unexpected and surprising in view of the prior art. For example, in typical processing environments it would not be expected that porous materials would offer significant efficiencies for filtration of particle sizes less than about 50 microns without also having much larger sized particles present in the oil. However, it is believed that the presently described use of porous materials to promote separation of suspended particles from fluids within an electrostatic separator, i.e., in a charged environment, can enable filtration of particle size ranges of less than 50 microns, even when larger sized particles are not present.

While the disclosed subject matter has been described in detail in connection with a number of embodiments, it is not limited to such disclosed embodiments. Rather, the disclosed subject matter can be modified to incorporate any number of variations, alterations, substitutions or equivalent arrangements not heretofore described, but which are commensurate with the scope of the disclosed subject matter.

Additionally, while various embodiments of the disclosed subject matter have been described, it is to be understood that aspects of the disclosed subject matter may include only some of the described embodiments. Accordingly, the disclosed subject matter is not to be seen as limited by the foregoing description, but is only limited by the scope of the claims.

What is claimed is:

1. A method of removing particle contaminants from a fluid stream within an electrostatic separator, comprising the steps of:
providing electrostatically-charged porous material within the electrostatic separator, the porous material being in an amount sufficient to filter the particle contaminants from the fluid stream; and
passing the fluid stream through the electostatically-charged porous material.

2. The method of claim 1, wherein the particles contaminants comprise catalyst material entrained in the fluid stream, and wherein the particle contaminants are filtered and retained by the porous materials.

3. The method of claim 1, wherein the porous materials provide void volumes in excess of 70% with surface areas exceeding 1000 square meters per cubic meter of material.

4. The method of claim 1, wherein the environment within the electrostatic separator is a charged environment, and wherein the porous materials enable filtration of particle size ranges of less than 50 microns when larger sized particles are not present in the oil.

5. The method of claim 1, wherein the porous materials are disposed as beds of randomly-packed elements within the electrostatic separator.

6. The method of claim 1, wherein the porous materials are disposed as one or more monolithic layers within the electrostatic separator.

7. The method of claim 1, wherein the porous materials are used together with glass beads within the separator.

8. The method of claim 1, wherein the porous materials are used without glass beads within the separator.

9. The method of claim 1, wherein the porous materials are reticulates.
